(19) United States
(12) Patent Application Publication
(10) Pub. No.: US 2023/0384090 A1
(43) Pub. Date: Nov. 30, 2023

(54) HIGH-PRECISION DUAL-AXIS LASER INCLINOMETER BASED ON WAVEFRONT HOMODYNE INTERFERENCE AND MEASURING METHOD

(71) Applicant: Harbin Institute of Technology, Harbin (CN)

(72) Inventors: Pengcheng Hu, Harbin (CN); Liang Yu, Harbin (CN)

(21) Appl. No.: 17/982,033

(22) Filed: Nov. 7, 2022

(30) Foreign Application Priority Data
May 27, 2022 (CN) 2022105857082

(51) Int. Cl. G01C 9/06; G01C 9/08

(52) U.S. Cl. CPC G01C 9/06; G01C 9/08; G01C 2009/066

(57) ABSTRACT

A high-precision dual-axis laser inclinometer based on wavefront homodyne interference and a measuring method are disclosed. The method includes: obtaining a laser signal through a laser light source module, transmitting the laser signal to an integrated sensing module, and generating a wavefront interference signal based on the integrated sensing module; and inputting the wavefront interference signal into a signal processing module for performing high-precision decoupling operation to obtain a horizontal inclination angle measurement result. The measurement resolution is high, the measurement result can be directly traced to the laser wavelength, high-precision dual-axis inclination angle measurement can be realized only by using single-beam measurement light, meanwhile, the laser inclinometer has the advantages of being simple in structure, simple in light path, easy to integrate, beneficial to engineering implementation, and high in cost performance, and the requirement of high-end equipment on the ultra-precision inclinometer is met.

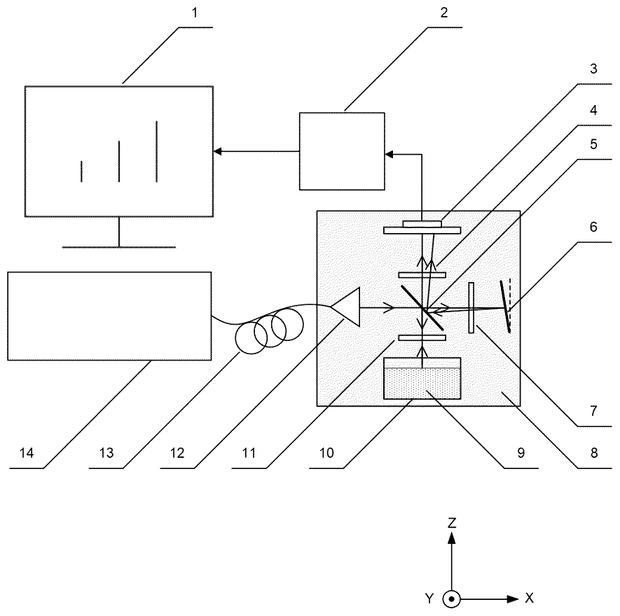

### TECHNICAL FIELD

The disclosure relates to the field of inclinometer technologies, and in particular, to a high-precision dual-axis laser inclinometer based on wavefront homodyne interference and a measuring method thereof.

### BACKGROUND

Precise inclinometer (also referred to as optoelectronic level) is an important measuring tool in the field of precision engineering, and can realize precise angle measurement with respect to an absolute horizontal plane, thus making it possible for leveling of high-end equipment and precise measurement of flatness and straightness. It has important applications in the field of high-end equipment manufacturing, precision metrology and frontier science represented by ultra-precision machine tools and large-scale scientific instruments. At present, the main technical route of the inclinometer can be divided into level type, inductive type, capacitive type and photoelectric type, etc.

The level type inclinometer mainly measures its inclination angle relative to the horizontal plane by determining the position of bubbles in the liquid. Since the liquid moves downwards under gravity, the bubbles in the liquid always move upwards accordingly and stay at the highest position. This principle can be used to measure the horizontal inclination angle. However, the division value of the traditional level type inclinometer can only reach 0.02˜0.05 millimeters per meter (mm/m) (about 4″-10″), and it can only be read by human eyes, resulting in lower measurement accuracy. Therefore, the above problems can be improved to a certain extent by replacing human eyes with an array detector to determine the position of bubbles. For example, Chinese patent with publication number of CN 113902894 A, published on Jan. 7, 2022, entitled “automatic reading identification method for bar inclinometer based on image processing”, discloses a new method based on computer vision; For another example, the article “a new kind of digital gradienter: principle and realization” published in the 3rd issue of Chinese Journal of Sensors and Actuators in 2001 introduced a method of using charge-coupled device (CCD) to obtain the position of bubbles, however, limited by the measurement principle based on the position of bubbles, this method is still difficult to achieve high-precision measurement, and cannot meet the measurement needs of high-end equipment such as precision machine tools.

The principle of the inductive type inclinometer (also referred to as inductive level) is that when the horizontal angle changes, the relative movement of a middle pendulum bob can cause voltage changes of inductive coils on the two sides, so as to calculate the angle information. For example, the Talyvel6 electronic inclinometer in the United Kingdom is a commercial product using this principle, the measurement range thereof is ±800″, the full-scale precision is ±8″, and the resolution of the central region is 0.1″. However, the inductive type inclinometer has complex mechanical closed-loop control structure, the electromagnetic shielding is needed, and the processing and installation errors of inductors are difficult to correct, so that the measurement result of the inductive type inclinometer does not have traceability.

The capacitive type inclinometer (also referred to as capacitive level) is widely applied in the market, and the principle thereof is to use the change of horizontal angles to cause the change of capacitance gaps and electrode plate mediums to generate unequal capacitance, and then obtain angle information from the change of the capacitance. For example, Chinese patent with publication number of CN 107677249 A, published on Feb. 9, 2018, entitled “high-precision pendulum bob capacitance inclinometry system and method for monitoring”, discloses a system for obtaining inclination angle by combining a capacitive sensor and a pendulum bob. For another example, a novel BLUETOOTH capacitive type electronic inclinometer named as BlueLEVEL for Swiss Dantsin Corporation is also a commercial product utilizing this principle that has a resolution of up to 1 micrometer per meter (μm/m) (about 0.2″) in a range of ±20 mm/m (about ±4000″), the stabilization time is about 3 seconds (s), but the linearity of capacitive type sensors is poor, the processing error also directly results in a large measurement error, the measurement precision depends on the calibration of instruments, the measurement result does not have traceability, and the requirement for the sealing technology is strict.

The photoelectric type inclinometer (also referred to as photoelectric level) is mainly based on a laser self-collimation technology, uses a liquid level as a reference, converts measured inclination angle changes into position changes of convergent light spot, and performs measurement by using a position sensitive detector (PSD). For example, an article “development of a high-sensitivity dual-axis optoelectronic level using double-layer liquid refraction” is published by issue 146 of Optics and Lasers in Engineering in 2021, the laser after multiple times of refraction by the liquid surface is measured by an autocollimator, the offset of light spot is obtained and the inclination angle information is calculated, so that the resolution reaches 0.05″, the range is ±150″, the repeatability is 0.4″, and the short-term stability is ±0.2″. For another example, an article “dual-axis optoelectronic level based on laser auto-collimation and liquid surface reflection” published by issue 113 of Optics & Laser Technology in 2019, and Chinese patent with publication number of CN 108871278 A, published on Nov. 23, 2018, entitled “liquid surface reflective dual-axis photoelectric level”, are the double-axis photoelectric levels designed by using laser auto-collimation principles. However, this inclinometer has high requirements on the position and attitude and processing accuracy of optical elements such as PSD and converging lens in the optical principle, and it is difficult to avoid processing and installation errors to directly introduce measurement errors, resulting in difficult direct tracing of measurement results.

In conclusion, the traditional level type inclinometer is low in precision and difficult to apply to precision engineering; the commercial inductive type inclinometer and capacitive type inclinometer can achieve high measurement resolution, but are limited by factors such as machining errors, and the measurement result cannot be traced; in recent years, some scholars set up the photoelectric type inclinometer based on the autocollimator, so that the measurement precision is further improved, but the measurement result is limited by the assembly error of the optical elements, and the measurement result is still difficult to directly trace. Therefore, there is a lack of a high-precision inclinometer that can be traced directly in the field of inclinometer technologies.

### SUMMARY

The object of the disclosure is to provide a high-precision dual-axis laser inclinometer based on wavefront homodyne interference and a measuring method, which can realize high-precision dual-axis horizontal inclination angle measurement, and measurement results can be directly traced to laser wavelengths.

In order to achieve the above purposes, the disclosure provides the following solution: a high-precision dual-axis laser inclinometer based on wavefront homodyne interference, includes:
a laser light source module, configured to generate a laser signal;
an integrated sensing module, connected to the laser light source module, and configured to receive the laser signal and generate a wavefront interference signal based on the laser signal;
a signal processing module, connected to the integrated sensing module, and configured to perform a high-precision decoupling operation on the wavefront interference signal to obtain a horizontal inclination angle measurement result.

Preferably, the laser light source module includes: a single-frequency laser and a polarization maintaining single mode patch cable;
the single-frequency laser is configured to provide linearly polarized light, and the linearly polarized light is the laser signal;
the polarization maintaining single mode patch cable is connected to the single-frequency laser and is configured to transmit the linearly polarized light to an optical fiber collimator.

Preferably, the integrated sensing module includes the optical fiber collimator, a polarization beam splitter, a reflector, a first quarter-wave plate, a second quarter-wave plate, a polarizer, a liquid container, a liquid unit, and an array detector;
the optical fiber collimator is configured to receive the linearly polarized light and output a linearly polarized collimated laser;
the polarization beam splitter is configured to divide the linearly polarized collimated laser into first transmitted light and first reflected light, and is further configured to reflect the first transmitted light having a polarization state converted into S to obtain first signal light, and transmit the first reflected light having a polarization state converted to P to obtain second signal light;
the first quarter-wave plate and the reflector are configured to convert the first transmitted light having a polarization state P into the first transmitted light having the polarization state S;
the second quarter-wave plate and the liquid unit are configured to convert the first reflected light having a polarization state S into the first reflected light having the polarization state P;
the polarizer is configured to select components of the first signal light and the second signal light in the same polarization direction, so that the first signal light and the second signal light form an interference;
the array detector is configured to detect the wavefront interference signal formed by the interference between the first signal light and the second signal light.

Preferably, the reflector is not perpendicular to the first transmitted light.

Preferably, the signal processing module includes a master computer and a signal processing board;
the signal processing board is configured to perform the high-precision decoupling operation on the wavefront interference signal through a dual-axis horizontal inclination angle decoupling algorithm, and upload an operation result (i.e., horizontal inclination angle measurement result) to the master computer;
the master computer is configured to receive, display, and store the operation result of the horizontal inclination angle measurement.

A measuring method of a high-precision dual-axis laser inclinometer based on wavefront homodyne interference, includes:
obtaining a laser signal through a laser light source module, transmitting the laser signal to an integrated sensing module, and generating a wavefront interference signal based on the integrated sensing module; and
inputting the wavefront interference signal into a signal processing module to perform a high-precision decoupling operation to obtain a horizontal inclination angle measurement result.

Preferably, a process of the obtaining a laser signal through a laser light source module and the transmitting the laser signal to an integrated sensing module includes: generating the laser signal through a single-frequency laser, and transmitting the generated laser signal to an optical fiber collimator through a polarization maintaining single mode patch cable.

Preferably, a process of the generating a wavefront interference signal based on the integrated sensing module includes:
receiving linearly polarized light through an optical fiber collimator and outputting linearly polarized collimated laser, dividing the linearly polarized collimated laser into first transmitted light and first reflected light after the linearly polarized collimated laser passes through a polarization beam splitter;
converting a polarization state of the first transmitted light from P to S by the first transmitted light passing through a first quarter-wave plate from a front thereof, and passing through the first quarter-wave plate from a back thereof after being reflected by the reflector; obtaining first signal light based on the converted first transmitted light through the polarizer after the converted first transmitted light is reflected by the polarization beam splitter, and transmitting the first signal light to the array detector;
converting a polarization state of the first reflected light from S to P by the first reflected light passing through a second quarter-wave plate from a front thereof, and passing through the second quarter-wave plate from a back thereof after being reflected by a liquid surface; obtaining second signal light based on the converted first reflected light through the polarizer after the converted first reflected light is reflected by the polarization beam splitter, and transmitting the second signal light to the array detector; and
making the first signal light and the second signal light form an interference at a detection surface of the array detector to obtain the wavefront interference signal.

Preferably, a process of the inputting the wavefront interference signal into a signal processing module to perform a high-precision decoupling operation to obtain a horizontal inclination angle measurement result includes: sending the wavefront interference signal to a signal processing board; performing, by the signal processing board, the high-precision decoupling operation on the wavefront interference signal through a dual-axis horizontal inclination angle decoupling algorithm to obtain the horizontal inclination angle measurement result, and uploading the horizontal inclination angle measurement result to a master computer.

Preferably, a process of the performing, by the signal processing board, the high-precision decoupling operation on the wavefront interference signal through a dual-axis horizontal inclination angle decoupling algorithm, includes:
converting the wavefront interference signal into a two-dimensional light intensity matrix, performing a butterfly operation-based two-dimensional discrete Fourier transform on the two-dimensional light intensity matrix to obtain a frequency space matrix of the wavefront interference signal, and calculating different spatial frequency components in an amplitude space of a spectrum of the wavefront interference signal;
obtaining an amplitude maximum value point and a corresponding position thereof in the frequency space matrix based on the amplitude space of the spectrum of the wavefront interference signal, and performing two-dimensional curve peak fitting by using amplitude information of the amplitude maximum value point and an adjacent matrix point to obtain fitted accurate frequency coordinates;
obtaining, according to an X component and a Y component of the fitted accurate frequency coordinates, included angles between a liquid surface and the reflector in a X direction and a Y direction respectively, according to formulas of linear relationships between an included angle of the liquid surface relative to the reflector and frequency of the wavefront interference signal.

The disclosure has the following technical effects:
(1) The high-precision dual-axis laser inclinometer based on wavefront homodyne interference and the measuring method provided by the disclosure are completely based on the principle of laser interference measurement, with the horizontal plane being a reference plane, the measurement resolution is high, and the measurement result can be directly traced to the laser wavelength.
(2) The laser inclinometer of the disclosure calculates horizontal inclination angles by means of the spatial frequency of the laser wavefront interference signal, and can implement dual-axis measurement only by using a single beam of measurement light (i.e., single measuring beam or single incident beam).
(3) The laser inclinometer of the disclosure improves the energy utilization efficiency by means of the conversion of the laser polarization state, reduces the virtual reflection in the optical path, has a low demand for laser power, and has a small periodic nonlinear error.
(4) The laser inclinometer of the disclosure is simple in structure, concise in light path, easy to integrate, beneficial to engineering implementation, and high in cost performance.

### BRIEF DESCRIPTION OF THE DRAWING

In order to more clearly illustrate the embodiments of the present disclosure or the technical solutions in the prior art, the accompanying drawing that need to be used in the embodiments are briefly described below, and it is obvious that the accompanying drawing in the following description is merely some of the embodiments of the present disclosure, and those skilled in the art may obtain other drawings according to this drawing without involving any inventive effort.

A FIGURE is a schematic structural diagram of a system according to an embodiment of the disclosure.

### DESCRIPTION OF REFERENCE NUMERALS

1—master computer, 2—signal processing board, 3—array detector, 4—polarizer, 5—polarization beam splitter, 6—reflector, 7—first quarter-wave plate, 8—integrated base, 9—liquid, 10—liquid container, 11—second quarter-wave plate, 12—optical fiber collimator, 13—polarization maintaining single mode patch cable, and 14—single-frequency laser.

### DETAILED DESCRIPTION OF THE EMBODIMENTS

In combination with the drawing in the embodiments of the disclosure, the technical solutions in the embodiments of the disclosure will be described clearly and completely. Apparently, the described embodiments are only some of the embodiments of the disclosure, not all of them. Based on the embodiments of the disclosure, all other embodiments obtained by those skilled in the art without creative work belong to the scope of the disclosure.

In order to make the above objects, features and advantages of the present disclosure more comprehensible, the present disclosure will be further described in detail below with reference to the accompanying drawings and specific embodiments.

### Embodiment 1

As shown in the FIGURE, the high-precision dual-axis laser inclinometer based on wavefront homodyne interference includes: a master computer 1, a signal processing board 2, an array detector 3, a polarizer 4, a polarization beam splitter 5, a reflector 6, a first quarter-wave plate 7, an integrated base 8, a liquid 9, a liquid container 10, a second quarter-wave plate 11, an optical fiber collimator 12, a polarization maintaining single mode patch cable 13, and a single-frequency laser 14. The optical fiber collimator 12, the polarization beam splitter 5, the reflector 6, the liquid container 10 and the array detector 3 are all fixed on the integrated base 8.

The liquid 9 has a viscosity value in the order of 100 centiStokes (cSt), a reflectivity of more than 1%, and a liquid surface height in the order of millimeters, which is a reference datum plane for horizontal inclination angles. The liquid container 10 is a circle with a diameter of more than 30 mm.

In the further optimized solution, the liquid 9 is silicone oil with a viscosity of 350 CS, reflectivity of about 3%, and a liquid surface height of 2 mm as a reference datum plane for horizontal inclination angles.

The reflector 6 is not perpendicular to the first transmitted light, so that the optical axis of the first signal light and the optical axis of the second signal light generate a slight angle deviation to form an inclined stripe-shaped wavefront interference signal, which is effectively detected by the array detector.

As shown in the FIGURE, the disclosure provides a high-precision dual-axis laser inclinometer based on wavefront homodyne interference, including: a laser light source module, an integrated sensing module, and a signal processing module.

The laser light source module includes a single-frequency laser 14 and a polarization maintaining single mode patch cable 13, and is configured to generate a linearly polarized laser, and an included angle between a polarization direction of the linearly polarized laser and a polarization direction of the P light is 1.77°.

The integrated sensing module includes an integrated base 8, an optical fiber collimator 12, a polarization beam splitter 5, a reflector 6, a first quarter-wave plate 7, a second quarter-wave plate 11, a liquid container 10, a liquid 9, a polarizer 4, and an array detector 3. The polarization beam splitter 5 divides the 1.77° linearly polarized light emitted by the optical fiber collimator 12 into first transmitted light and first reflected light. The first transmitted light is reflected by the reflector 6, and passes through the first quarter-wave plate 7 in front and back directions to form first signal light, that is to say, the first transmitted light passes through the first quarter-wave plate 7 from the front thereof and passes through the first quarter-wave plate 7 from the back thereof after being reflected by the reflector 6, and the first signal light can be obtained.

The first reflected light is reflected by the liquid surface, and passes through the second quarter-wave plate 11 in front and back directions to form the second signal light, that is to say, the first reflected light passes through the second quarter-wave plate 11 from the front thereof and passes through the second quarter-wave plate 11 from the back thereof after being reflected by the liquid surface, and the second signal light can be obtained. After the first signal light and the second signal light pass through the polarizer 4 together, interference occurs at the detection surface of the array detector 3 to form the wavefront interference signal.

The signal processing module includes a master computer 1 and a signal processing board 2.

The signal processing board 2 is configured to perform a high-precision decoupling operation on the wavefront interference signal through a dual-axis horizontal inclination angle decoupling algorithm, and upload an operation result (i.e., horizontal inclination angle measurement result) to the master computer 1.

The master computer 1 is configured to receive, display, and store an operation result of the horizontal inclination angle measurement.

The disclosure further provides a measuring method of a high-precision dual-axis laser inclinometer based on wavefront homodyne interference, and a measuring process based on the laser inclinometer is as follows: the single-frequency laser 14 of the embodiment adopts a 633 nanometers (nm) single-frequency helium-neon laser for providing a frequency-stabilized laser signal, the laser signal is linearly polarized light and is transmitted to the optical fiber collimator 12 through the polarization maintaining single mode patch cable 13, the optical fiber collimator 12 outputs linearly polarized collimated laser, and the included angle between the polarization direction of the linearly polarized collimated laser and the polarization direction of the P-light is 1.77°. The 1.77° linearly polarized collimated laser passes through the polarization beam splitter 5 and then is divided into first transmitted light and first reflected light; the first transmitted light with the polarization state P is successively transmitted by the first quarter-wave plate 7, reflected by the reflector 6, and returned after the reverse transmission of the first quarter-wave plate 7, its polarization state is changed into S, and then the first transmitted light becomes the first signal light through the polarizer 4 after being reflected by the polarization beam splitter 5, and the polarization state is 45°. Meanwhile, the first reflected light with the polarization state S is successively transmitted by the second quarter-wave plate 11, reflected by the liquid surface of the liquid 9, and returned after the reverse transmission of the second quarter-wave plate 11, its polarization state is changed into P, and then the first reflected light becomes second signal light through the polarizer 4 after being transmitted through the polarization beam splitter 5, and the polarization state is 45°; and the reflector 6 is not perpendicular to the first transmitted light, the optical axis of the first signal light and the optical axis of the second signal light are caused to generate a tiny angle deviation, so that an inclined stripe-shaped wavefront interference signal is formed on the detection surface of the array detector 3, and is detected by the array detector 3. The wavefront interference signal is sent to the signal processing board 2 in a digital quantity form, a dual-axis horizontal inclination angle decoupling algorithm is integrated in the signal processing board 2, the high-precision decoupling operation is performed on the wavefront interference signal, and an operation result is uploaded to the master computer 1; and the dual-axis horizontal inclination angle decoupling algorithm of the laser inclinometer can perform the high-precision decoupling operation on the wavefront interference signal and trace the horizontal inclination angle measurement to the laser wavelength.

The process of tracing the horizontal inclination angle by the dual-axis horizontal inclination angle decoupling algorithm to the laser wavelength includes:
step 1: converting the wavefront interference signal into a two-dimensional grayscale matrix (i.e., two-dimensional light intensity matrix), performing a butterfly operation-based two-dimensional discrete Fourier transform on the two-dimensional grayscale matrix to obtain a frequency space matrix thereof, and calculating different spatial frequency components thereof in an amplitude space of a spectrum thereof;
step 2, obtaining an amplitude maximum point and the corresponding position thereof in the frequency space matrix in the amplitude space of the two-dimensional frequency spectrum of the wavefront interference signal, and performing two-dimensional curve peak fitting by using amplitude information of the amplitude maximum amplitude point and the adjacent matrix point to obtain the fitted accurate frequency coordinates;
step 3: the angle of the liquid surface relative to the reflector is in a linear relationship with the frequency of the wavefront interference signal, and according to the X component and the Y component of the accurate frequency coordinate obtained by fitting, the included angle between the liquid surface and the reflector in the X direction and the Y direction may be respectively obtained according to formula 1 and formula 2. Due to the fact that the liquid surface is always perpendicular to the gravity direction, the method can calculate and monitor the dual-axis horizontal inclination angle of the plane in real time.

$${θ}_{X} = \frac{λ {f}_{X}}{2 {n}_{a i r}} \approx \frac{λ {f}_{X}}{2} \qquad ( 1 )$$

$${θ}_{Y} = \frac{λ {f}_{Y}}{2 {n}_{a i r}} \approx \frac{λ {f}_{Y}}{2} \qquad ( 2 )$$

In the formulas, θ_{X} and θ_{Y} represent horizontal inclination angles in the x and y directions, respectively; f_{X} and f_{Y} represent x and y components of the spatial frequency of the wavefront interference signal, respectively; λ represent the laser wavelength, and nₐᵢᵣ represent the air refractive index.

In the measuring method of the high-precision dual-axis laser inclinometer based on wavefront homodyne interference provided by the disclosure, the horizontal plane is taken as the reference datum plane, a wavefront homodyne interference principle of linear polarization laser is utilized, a to-be-measured horizontal inclination angle is converted into a wavefront interference signal through a liquid surface and attitude inclined reflector, high-precision decoupling calculation is conducted on the wavefront interference signal, and finally high-precision double-axis measurement of the horizontal inclination angle is achieved. In addition, by converting the laser polarization state and cooperating with the polarization beam splitter, the energy utilization efficiency is improved, the requirement for the laser power is reduced, and the virtual reflection in the optical path and the periodic nonlinear error caused thereby are also reduced. The laser inclinometer of the disclosure is completely based on the principle of laser interference measurement, the measurement resolution is high, the measurement result can be directly traced to the laser wavelength, and the laser inclinometer has the advantages of simple structure, concise optical path, easy integration, facilitation of engineering implementation, high cost performance and the like, and meets the requirements of high-end equipment on the ultra-precision inclinometer.

The above embodiments are only described in the preferred manner of the present disclosure, and are not limited to the scope of the present disclosure, and various modifications and improvements made by those of ordinary skill in the art on the technical solutions of the present disclosure shall fall within the scope of protection determined by the claims of the present disclosure without departing from the spirit of the present disclosure.

What is claimed is:

1. A dual-axis laser inclinometer based on wavefront homodyne interference, comprising:
a laser light source module, configured to generate a laser signal;
an integrated sensing module, connected to the laser light source module, and configured to receive the laser signal and generate a wavefront interference signal based on the laser signal; and
a signal processing module, connected to the integrated sensing module, and configured to perform a decoupling operation on the wavefront interference signal to obtain a horizontal inclination angle measurement result.

2. The dual-axis laser inclinometer based on wavefront homodyne interference according to claim 1, wherein the laser light source module comprises a single-frequency laser and a polarization maintaining single mode patch cable;
the single-frequency laser is configured to provide linearly polarized light, and the linearly polarized light is the laser signal;
the polarization maintaining single mode patch cable is connected to the single-frequency laser and is configured to transmit the linearly polarized light to an optical fiber collimator.

3. The dual-axis laser inclinometer based on wavefront homodyne interference according to claim 1, wherein the integrated sensing module comprises an optical fiber collimator, a polarization beam splitter, a reflector, a first quarter-wave plate, a second quarter-wave plate, a polarizer, a liquid container, a liquid unit, and an array detector;
the optical fiber collimator is configured to receive linearly polarized light and output a linearly polarized collimated laser;
the polarization beam splitter is configured to divide the linearly polarized collimated laser into first transmitted light and first reflected light, and further configured to reflect the first transmitted light having a polarization state converted to S to obtain first signal light, and transmit the first reflected light having a polarization state converted to P to obtain second signal light;
the first quarter-wave plate and the reflector are configured to convert the first transmitted light having a polarization state P into the first transmitted light having the polarization state S;
the second quarter-wave plate and the liquid unit are configured to convert the first reflected light having a polarization state S into the first reflected light having the polarization state P;
the polarizer is configured to select components of the first signal light and the second signal light in a same polarization direction to make the first signal light and the second signal light form an interference; and
the array detector is configured to detect the wavefront interference signal formed by the interference between the first signal light and the second signal light.

4. The dual-axis laser inclinometer based on wavefront homodyne interference according to claim 3, wherein the reflector is not perpendicular to the first transmitted light.

5. The dual-axis laser inclinometer based on wavefront homodyne interference according to claim 1, wherein the signal processing module comprises a master computer and a signal processing board;
the signal processing board is configured to perform the decoupling operation on the wavefront interference signal through a dual-axis horizontal inclination angle decoupling algorithm, and upload the horizontal inclination angle measurement result to the master computer; and
the master computer is configured to receive, display and store the horizontal inclination angle measurement result.

6. A measuring method of a dual-axis laser inclinometer based on wavefront homodyne interference, comprising:
obtaining a laser signal through a laser light source module, transmitting the laser signal to an integrated sensing module, and generating a wavefront interference signal based on the integrated sensing module; and
inputting the wavefront interference signal into a signal processing module to perform a decoupling operation to obtain a horizontal inclination angle measurement result.

7. The measuring method of the dual-axis laser inclinometer based on wavefront homodyne interference according to claim 6, wherein a process of the obtaining a laser signal through a laser light source module and the transmitting the laser signal to an integrated sensing module, comprises:
generating the laser signal through a single-frequency laser, and transmitting the generated laser signal to an optical fiber collimator through a polarization maintaining single mode patch cable.

8. The measuring method of the dual-axis laser inclinometer based on wavefront homodyne interference according to claim 6, wherein a process of the generating a wavefront interference signal based on the integrated sensing module, comprises:
receiving linearly polarized light through an optical fiber collimator and outputting a linearly polarized collimated laser;
dividing the linearly polarized collimated laser into first transmitted light and first reflected light after the linearly polarized collimated laser passes through a polarization beam splitter;
converting a polarization state of the first transmitted light from P to S by the first transmitted light passing through a first quarter-wave plate from a front thereof, and passing through the first quarter-wave plate from a back thereof after being reflected by the reflector; obtaining first signal light based on the converted first transmitted light through the polarizer after the converted first transmitted light is reflected by the polarization beam splitter, and transmitting the first signal light to the array detector;
converting a polarization state of the first reflected light from S to P by the first reflected light passing through a second quarter-wave plate from a front thereof, and passing through the second quarter-wave plate from a back thereof after being reflected by a liquid surface; obtaining second signal light based on the converted first reflected light through the polarizer after the converted first reflected light is reflected by the polarization beam splitter, and transmitting the second signal light to the array detector; and
making the first signal light and the second signal light form an interference at a detection surface of the array detector to obtain the wavefront interference signal.

9. The measuring method of the dual-axis laser inclinometer based on wavefront homodyne interference according to claim 6, wherein a process of the inputting the wavefront interference signal into a signal processing module to perform a decoupling operation to obtain a horizontal inclination angle measurement result, comprises:
sending the wavefront interference signal to a signal processing board;
performing, by the signal processing board, the decoupling operation on the wavefront interference signal through a dual-axis horizontal inclination angle decoupling algorithm to obtain the horizontal inclination angle measurement result, and uploading the horizontal inclination angle measurement result to a master computer.

10. The measuring method of the dual-axis laser inclinometer based on wavefront homodyne interference according to claim 9, wherein a process of the performing, by the signal processing board, the decoupling operation on the wavefront interference signal through a dual-axis horizontal inclination angle decoupling algorithm, comprises:
converting the wavefront interference signal into a two-dimensional light intensity matrix, performing a butterfly operation-based two-dimensional discrete Fourier transform on the two-dimensional light intensity matrix to obtain a frequency space matrix of the wavefront interference signal, and calculating different spatial frequency components in an amplitude space of a spectrum of the wavefront interference signal;
obtaining an amplitude maximum value point and a corresponding position thereof in the frequency space matrix based on the amplitude space of the spectrum of the wavefront interference signal, and performing two-dimensional curve peak fitting by using amplitude information of the amplitude maximum value point and an adjacent matrix point to obtain fitted accurate frequency coordinates; and
obtaining, according to an X component and a Y component of the fitted accurate frequency coordinates, included angles between a liquid surface and the reflector in a X direction and a Y direction respectively, according to formulas of linear relationships between an included angle of the liquid surface relative to the reflector and frequency of the wavefront interference signal.
